(19) United States
(12) Patent Application Publication
(10) Pub. No.: US 2026/0184536 A1
(43) Pub. Date: Jul. 2, 2026

(54) ELEVATOR GOVERNOR ASSEMBLY WITH DAMPER

(71) Applicant: Otis Elevator Company, Farmington, CT (US)

(72) Inventor: YiSug Kwon, Farmington, CT (US)

(21) Appl. No.: 19/005,265

(22) Filed: Dec. 30, 2024

(51) Int. Cl. B66B 5/04

(52) U.S. Cl. CPC B66B 5/046; B66B 5/042

(57) ABSTRACT

A governor assembly for an elevator car. The governor assembly includes a tripping sheave; a centrifugal tripping mechanism configured to rotate with the tripping sheave, the centrifugal tripping mechanism configured to initiate activation of an elevator car safety brake; the centrifugal tripping mechanism including a first weight member configured to move in response to rotational speed of the centrifugal tripping mechanism; and a first damper coupled to the first weight member.

### BACKGROUND

The embodiments described herein relate to overspeed governors for elevators and particularly to elevator governor assemblies having a damper to dampen motion of weight members of an elevator governor assembly.

Elevator systems may include a safety system to stop an elevator car from traveling at excessive speeds. Traditionally, elevator safety systems include a mechanical speed sensing device commonly referred to as an overspeed governor, a governor rope, and a mechanical linkage connected to a safety gear for selectively frictionally engaging elevator guiderails. The overspeed governor may be mounted on the car, in a machine room or in the hoistway. The safety system is mounted on the car, and a linkage or governor rope hitch connects the system with the governor. When the governor detects a dangerous situation due to excessive travelling speed, it sends a force to the safety gear through the tensioned governor rope and linkage. The safety gear then engages the guiderails and stops the elevator car.

Some overspeed governors perform electronic triggering. As the elevator car speed increases, weight members of an elevator governor assembly expand outwards due to centrifugal force. One or more of the weight members contacts a switch or activates a sensor which generates an electrical signal to electronically trigger safety operations. A first switch/sensor may disable power to the machine that imparts motion to the elevator car. A second switch/sensor may initiate activating an elevator car safety brake (e.g., causing the elevator car safety brake to engage a guiderail).

Governor assemblies are designed to activate an elevator car safety brake in response to speed. In some situations, acceleration of the elevator car can cause the governor assembly to inadvertently activate the elevator car safety brake. For example, in the event of an emergency stop during upward travel with a light or empty elevator car, the governor assembly can activate the elevator car safety brake. This is due to, for example, an acceleration of the elevator car upward during a delay between power shutoff to the elevator machine and activating the machine brake. When the mass difference between counterweight and empty car (e.g., system overbalance) is greater, this acceleration increases. The governor assembly may also activate the elevator car safety brake in response to erratic behavior of passengers in the elevator car (e.g., jumping, dancing, etc.) which causes an elevator car acceleration significant enough to activate the elevator car safety brake.

### SUMMARY

According to an embodiment, a governor assembly for an elevator car includes a tripping sheave; a centrifugal tripping mechanism configured to rotate with the tripping sheave, the centrifugal tripping mechanism configured to initiate activation of an elevator car safety brake; the centrifugal tripping mechanism including a first weight member configured to move in response to rotational speed of the centrifugal tripping mechanism; and a first damper coupled to the first weight member.

In addition to one or more of the features described herein, or as an alternative, further embodiments may include wherein the first damper is a rotary damper.

In addition to one or more of the features described herein, or as an alternative, further embodiments may include wherein the first damper includes a housing; a rotor positioned in the housing; and a damping medium in the housing.

In addition to one or more of the features described herein, or as an alternative, further embodiments may include wherein the first damper includes a first connection point configured for connection to the first weight member; and a second connection point configured for connection to the tripping sheave.

In addition to one or more of the features described herein, or as an alternative, further embodiments may include wherein the first damper is located at a pivot point between the first weight member and the tripping sheave.

In addition to one or more of the features described herein, or as an alternative, further embodiments may include wherein the centrifugal tripping mechanism further includes a second weight member configured to move in response to rotational speed of the centrifugal tripping mechanism.

In addition to one or more of the features described herein, or as an alternative, further embodiments may include wherein the first damper is coupled to the second weight member.

In addition to one or more of the features described herein, or as an alternative, further embodiments may include wherein the first damper is located at a pivot point between the first weight member and the second weight member.

In addition to one or more of the features described herein, or as an alternative, further embodiments may include a second damper coupled to the second weight member.

In addition to one or more of the features described herein, or as an alternative, further embodiments may include wherein the second damper includes a first connection point configured for connection to the second weight member; a second connection point configured for connection to the tripping sheave.

In addition to one or more of the features described herein, or as an alternative, further embodiments may include a spring connected to the first weight member.

In addition to one or more of the features described herein, or as an alternative, further embodiments may include wherein the centrifugal tripping mechanism initiates activation of the elevator car safety brake through a mechanical linkage.

In addition to one or more of the features described herein, or as an alternative, further embodiments may include wherein the centrifugal tripping mechanism initiates activation of the elevator car safety brake through an electrical signal.

According to another embodiment, an elevator system includes a hoistway; an elevator car configured to travel in the hoistway; and a governor assembly.

In addition to one or more of the features described herein, or as an alternative, further embodiments may include wherein the governor assembly is mounted to the elevator car.

In addition to one or more of the features described herein, or as an alternative, further embodiments may include wherein the governor assembly is mounted in the hoistway.

The foregoing features and elements may be combined in various combinations without exclusivity, unless expressly indicated otherwise. These features and elements as well as the operation thereof will become more apparent in light of the following description and the accompanying drawings. It should be understood, however, that the following description and drawings are intended to be illustrative and explanatory in nature and non-limiting.

### BRIEF DESCRIPTION OF THE DRAWINGS

The present disclosure is illustrated by way of example and not limited in the accompanying figures in which like reference numerals indicate similar elements.

FIG. 1 is a schematic illustration of an elevator system that may employ various embodiments of the present disclosure.

FIG. 2 is a perspective view of a governor assembly in an example embodiment.

FIG. 3 depicts elements of a governor assembly in an example embodiment.

FIG. 4 depicts a damper in an example embodiment.

### DETAILED DESCRIPTION

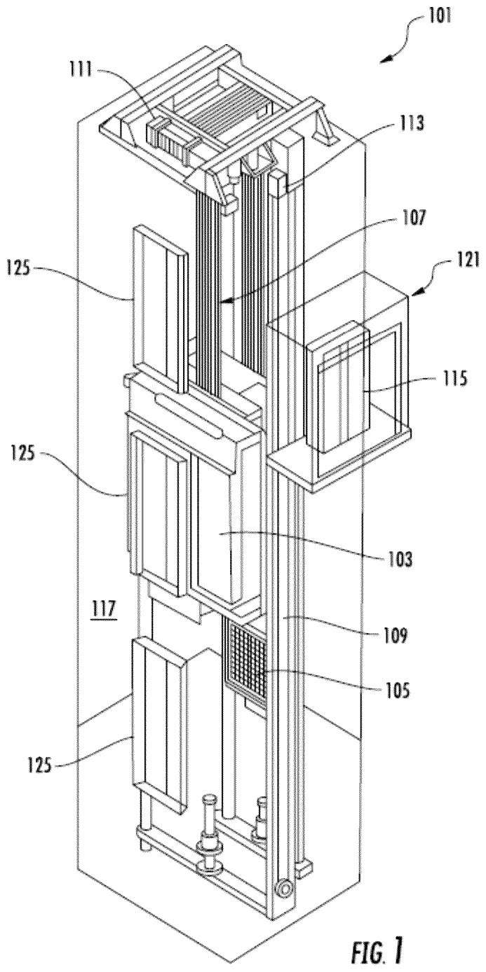

FIG. 1 is a perspective view of an elevator system 101 including an elevator car 103, a counterweight 105, a tension member 107, a guiderail 109, a machine 111, a position reference system 113, and a controller 115. The elevator car 103 and counterweight 105 are connected to each other by the tension member 107. The tension member 107 may include or be configured as, for example, ropes, steel cables, and/or coated-steel belts. The counterweight 105 is configured to balance a load of the elevator car 103 and is configured to facilitate movement of the elevator car 103 concurrently and in an opposite direction with respect to the counterweight 105 within an elevator shaft or hoistway 117 and along the guiderail 109.

The tension member 107 engages the machine 111, which is part of an overhead structure of the elevator system 101. The machine 111 is configured to control movement between the elevator car 103 and the counterweight 105. The position reference system 113 may be mounted on a fixed part at the top of the hoistway 117, such as on a support or guiderail, and may be configured to provide position signals related to a position of the elevator car 103 within the hoistway 117. In other embodiments, the position reference system 113 may be directly mounted to a moving component of the machine 111, or may be located in other positions and/or configurations as known in the art. The position reference system 113 can be any device or mechanism for monitoring a position of the elevator car 103 and/or the counterweight 105, as known in the art. For example, without limitation, the position reference system 113 can be an encoder, sensor, or other system and can include velocity sensing, absolute position sensing, etc., as will be appreciated by those of skill in the art.

The controller 115 may be located, as shown, in a controller room 121 of the hoistway 117 and is configured to control the operation of the elevator system 101, and particularly the elevator car 103. It is to be appreciated that the controller 115 need not be in the controller room 121 but may be in the hoistway 117 or other location in the elevator system. The controller 115 may provide drive signals to the machine 111 to control the acceleration, deceleration, leveling, stopping, etc. of the elevator car 103. The controller 115 may also be configured to receive position signals from the position reference system 113 or any other position reference device. When moving up or down within the hoistway 117 along guiderail 109, the elevator car 103 may stop at one or more landings 125 as controlled by the controller 115. Although shown in the controller room 121, those of skill in the art will appreciate that the controller 115 can be located and/or configured in other locations or positions within the elevator system 101. In one embodiment, the controller 115 may be located remotely or in a distributed computing network (e.g., cloud computing architecture). The controller 115 may be implemented using a processor-based machine, such as a personal computer, server, distributed computing network, etc.

The machine 111 may include a motor or similar driving mechanism. In accordance with embodiments of the disclosure, the machine 111 is configured to include an electrically driven motor. The power supply for the motor may be any power source, including a power grid, which, in combination with other components, is supplied to the motor. The machine 111 may include a traction sheave that imparts force to tension member 107 to move the elevator car 103 within hoistway 117. The machine 111 may also include a brake to stop motion of the elevator car 103.

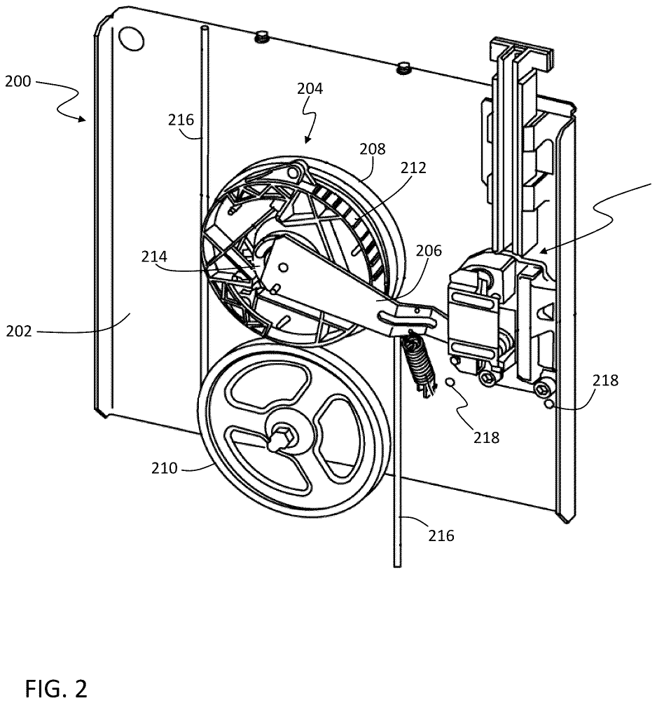

FIG. 2 is a perspective view of a car mounted overspeed governor assembly 200 which is configured to provide a safety feature to the elevator car 103. In operation, the car mounted overspeed governor assembly 200 enables the efficient stopping of the elevator car 103 during an overspeed event.

As shown in FIG. 2, a chassis 202 supports a governor 204. The governor 204 includes a safety lever 206, a tripping sheave 208, an idler sheave 210, a centrifugal tripping mechanism 212, and a tripping ring 214. Also shown in FIG. 2 is a cable 216, which may be a cable, rope, wire, etc. that is configured to extend between the top and bottom of an elevator shaft or hoistway 117.

The chassis 202 is configured to be attached to an outside surface, structure, or side of the elevator car 103, such as an upright of the elevator car 103 near the guiderail 109 upon which the elevator car 103 travels. The chassis 202 can be sheet metal and includes attachment points for the governor 204 and associated components. Further, the chassis 202 can include one or more apertures 218 configured to attach the chassis 202, and thus governor 204, to the structure or surface of the elevator.

The chassis 202 also supports a safety device 220 that is configured to engage or trigger in an overspeed condition of the elevator, to thus provide a safety mechanism employing the governor 204. In an exemplary embodiment, the triggering device may include the centrifugal tripping mechanism 212 attached to the tripping sheave 208 which is rotatably mounted to the chassis 202. The idler sheave 210 is also rotatably mounted to the chassis 202 and adjacent to tripping sheave 208, as shown in FIG. 2. The cable 216 may be anchored at a top of the elevator shaft or hoistway 117 and may be free hanging. The cable 216 may further be tensioned by a mass at a bottom of the elevator shaft or hoistway 117. At the car mounted governor assembly 200, the cable 216 travels around tripping sheave 208 and idler sheave 210 in an “S”-like pattern or winding. For example, the cable 216 extends downward on the left side of FIG. 1, wraps around the bottom of idler sheave 210, winds upward and to the left in FIG. 2, wraps around tripping sheave 208, and then extends downward on the right side of the tripping sheave 208.

In operation, as the elevator car 103 moves up and down within an elevator shaft or hoistway, the cable 216 transfers the elevator car speed to the governor 204 by looping around the tripping sheave 208 and the idler sheave 210, as described above. The centrifugal tripping mechanism 212 rotates with the tripping sheave 208. In the event of an overspeed condition as the elevator car 103 travels, the centrifugal tripping mechanism 212 couples tripping sheave 208 to tripping ring 214. This occurs in response to weight members of the centrifugal tripping mechanism 212 pivoting outwards in response to centrifugal force. Once coupled, the tripping ring 214 moves with the tripping sheave 208, both rotating in a counterclockwise direction in FIG. 2. The force of the rotation from the tripping ring 214 is transferred to the safety lever 206. The counterclockwise movement of the safety lever 206 then causes the safety device 220 to frictionally engage with the guiderail 109 or other structure in the shaft or hoistway 117 to slow down or stop the elevator car 103.

The governor assembly in the example embodiment of FIG. 2 is a car mounted governor assembly. Embodiments of this disclosure are not limited to car mounted governor assemblies, but also apply to governor assemblies mounted in other locations, for example, in the hoistway 117, in a machine room, etc.

The governor assembly 200 in the example embodiment of FIG. 2 mechanically activates the safety device 220 through the safety lever 206. Embodiments of this disclosure are not limited to governor assemblies that mechanically activate the elevator car safety brake. In some embodiments, a switch contact or sensor (not shown) is used to electrically activate the elevator car safety brake. As the speed of the elevator car 103 increases, the weight members of the centrifugal tripping mechanism 212 pivot outwards in response to centrifugal force. At a set speed, one of the weight members makes physical contact with the switch contact or is detected by the sensor. A signal from the switch contact or sensor is sent to a controller that initiates activation the elevator car safety brake. Such a system is described in U.S. patent application publication 2024/0199376, the entire contents of which are incorporated herein by reference.

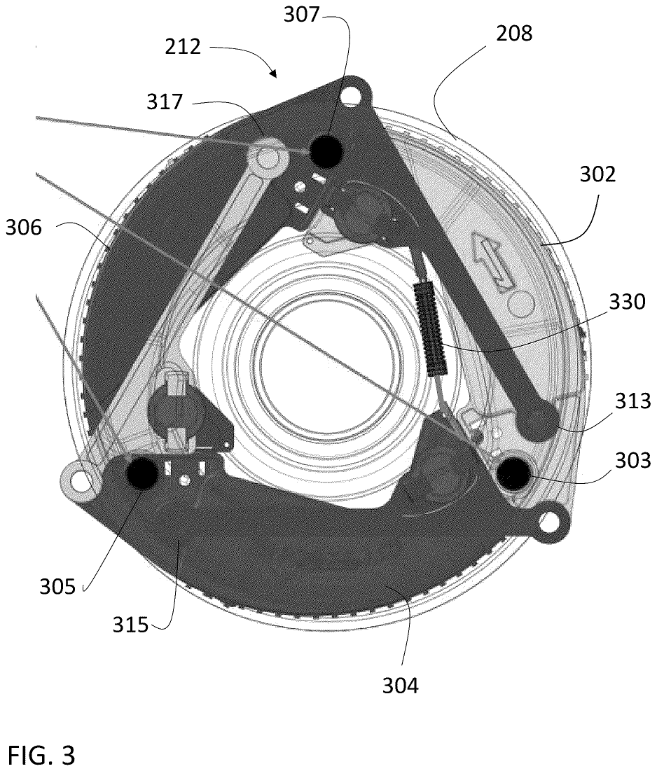

Embodiments of this disclosure use one or more dampers in the governor assembly 200 to prevent activation of the elevator car safety brake in response to acceleration rather than speed. FIG. 3 depicts a tripping sheave 208 and a centrifugal tripping mechanism 212 of a governor assembly 200 in an example embodiment. The tripping mechanism 212 includes, for example, three weight members 302, 304 and 306. It is understood that the tripping mechanism 212 may include more than or less than three weight members 302, 304 and 306.

The weight members 302, 304 and 306 are pivotally connected to the tripping sheave 208 at first pivot locations 303, 305 and 307. Each of the first pivot locations 303, 305 and 307 may include a shaft that allows rotation of a respective weight member 302, 304 and 306 relative to the tripping sheave 208. The weight members 302, 304 and 306 are also pivotally connected to each other at second pivot locations 313, 315 and 317. Each of the second pivot locations 313, 315 and 317 may include a shaft that allows rotation of a respective weight member 302, 304 and 306 relative to a respective adjacent weight member 302, 304 and 306.

In an embodiment, at least one of the first pivot locations 303, 305 and 307 includes a damper to dampen rotary motion between a respective weight member 302, 304 and 306 and the tripping sheave 208. One, two or three of the first pivot locations 303, 305 and 307 may include a damper. The damper may replace the shaft pivotally coupling a respective weight member 302, 304 and 306 and the tripping sheave 208.

In another embodiment, at least one of the second pivot locations 313, 315 and 317 includes a damper to dampen rotary motion between a weight member 302, 304 and 306 and an adjacent weight member 302, 304 and 306. One, two or three of the second pivot locations 313, 315 and 317 may include a damper. The damper may replace the shaft pivotally coupling a respective weight member 302, 304 and 306 to an adjacent weight member 302, 304 and 306.

A damper may also be used at one or more of the first pivot locations 303, 305 and 307 in conjunction with a damper at one or more of the second pivot locations 313, 315 and 317. The number and location of the damper(s) used may vary based on application of the governor assembly 200.

The tripping mechanism 212 may also include one or more springs 330 connected to one or more of the weight members 302, 304 and 306. FIG. 3 depicts a spring 330 connecting weight members 304 and 306. Additional springs may be used between other weight members 302, 304 and 306. The one or more springs 330 are used to preload one or more of the weight members 302, 304 and 306. The one or more springs 330 may be a linear spring (as shown in FIG. 3) or a torsion spring as described in U.S. Pat. No. 11,453,571. One or more dampers may be used in conjunction with one or more springs.

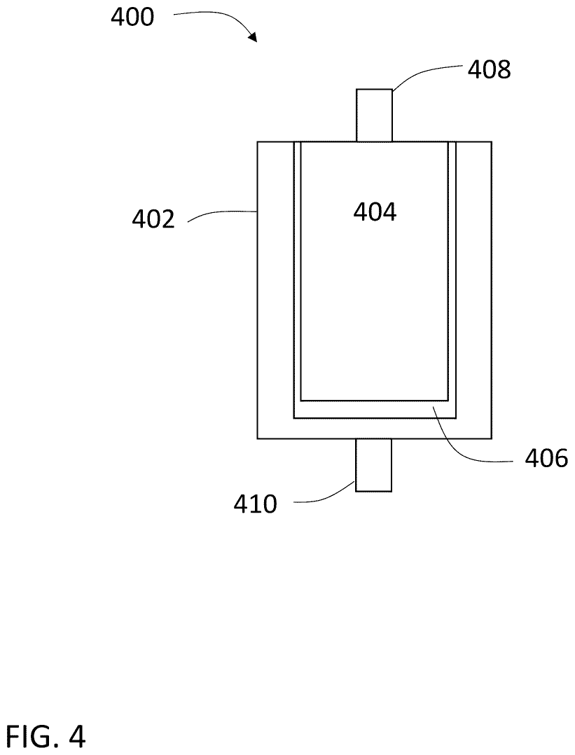

FIG. 4 depicts a damper 400 in an example embodiment. The damper 400 is a rotary damper and includes a cylindrical housing 402 and a cylindrical rotor 404. The housing 402 contains a damping medium 406, such as a viscous fluid or a series of frictional elements. The primary function of the rotary damper 400 is to absorb and dissipate kinetic energy, thereby reducing the amplitude of oscillations and stabilizing motion of one or more of the weight members 302, 304 and 306. The damping medium 406 within the housing 402 provides a damping effect. The damping medium 406 may be a viscous fluid (such as oil or silicone) or a series of frictional elements (such as pads or discs). As the rotor 404 moves, it encounters resistance from the damping medium 406, which absorbs energy and reduces motion. Seals, such as o-rings, may be used to contain the damping medium 406 in the housing 402, as necessary.

The damper 400 includes a first connection point 408 and a second connection point 410. In one embodiment, the first connection point 408 is connected to one of the weight members 302, 304 and 306 and the second connection point 410 is connected to the tripping sheave 208. In this embodiment, the damper 400 is located at one of the pivot points 303, 305 or 307. In another embodiment, the first connection point 408 is connected to one of the weight members 302, 304 and 306 and the second connection point 410 is connected to another of the weight member 302, 304 and 306. In this embodiment, the damper 400 is located at one of the second pivot points 313, 315 or 317.

Using one or more dampers 400 reduces sensitivity of the weight members 302, 304 and 306 to acceleration of the elevator car 103, which makes the governor assembly 200 robust to brake emergency stops and abnormal passenger behavior events. Embodiments prevent governor assemblies from inadvertently activating the elevator car safety brake during brake emergency stops or abnormal passenger behavior.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

Those of skill in the art will appreciate that various example embodiments are shown and described herein, each having certain features in the particular embodiments, but the present disclosure is not thus limited. Rather, the present disclosure can be modified to incorporate any number of variations, alterations, substitutions, combinations, sub-combinations, or equivalent arrangements not heretofore described, but which are commensurate with the scope of the present disclosure. Additionally, while various embodiments of the present disclosure have been described, it is to be understood that aspects of the present disclosure may include only some of the described embodiments. Accordingly, the present disclosure is not to be seen as limited by the foregoing description, but is only limited by the scope of the appended claims.

What is claimed is:

1. A governor assembly for an elevator car, the governor assembly comprising:
a tripping sheave;
a centrifugal tripping mechanism configured to rotate with the tripping sheave, the centrifugal tripping mechanism configured to initiate activation of an elevator car safety brake;
the centrifugal tripping mechanism including a first weight member configured to move in response to rotational speed of the centrifugal tripping mechanism; and
a first damper coupled to the first weight member.

2. The governor assembly of claim 1, wherein the first damper is a rotary damper.

3. The governor assembly of claim 2, wherein the first damper comprises:
a housing;
a rotor positioned in the housing; and
a damping medium in the housing.

4. The governor assembly of claim 3, wherein the first damper comprises:
a first connection point configured for connection to the first weight member; and
a second connection point configured for connection to the tripping sheave.

5. The governor assembly of claim 4, wherein the first damper is located at a pivot point between the first weight member and the tripping sheave.

6. The governor assembly of claim 1, wherein the centrifugal tripping mechanism further comprises:
a second weight member configured to move in response to rotational speed of the centrifugal tripping mechanism.

7. The governor assembly of claim 6, wherein the first damper is coupled to the second weight member.

8. The governor assembly of claim 7, wherein the first damper is located at a pivot point between the first weight member and the second weight member.

9. The governor assembly of claim 6, further comprising:
a second damper coupled to the second weight member.

10. The governor assembly of claim 9, wherein the second damper comprises:
a first connection point configured for connection to the second weight member; and
a second connection point configured for connection to the tripping sheave.

11. The governor assembly of claim 1, further comprising:
a spring connected to the first weight member.

12. The governor assembly of claim 1, wherein the centrifugal tripping mechanism initiates activation of the elevator car safety brake through a mechanical linkage.

13. The governor assembly of claim 1, wherein the centrifugal tripping mechanism initiates activation of the elevator car safety brake through an electrical signal.

14. An elevator system comprising:
a hoistway;
an elevator car configured to travel in the hoistway; and
a governor assembly according to claim 1.

15. The elevator system of claim 14, wherein the governor assembly is mounted to the elevator car.

16. The elevator system of claim 14, wherein the governor assembly is mounted in the hoistway.
